(19) United States
(12) Patent Application Publication
(10) Pub. No.: US 2026/0179170 A1
(43) Pub. Date: Jun. 25, 2026

(54) ENHANCED CONCURRENT BINNING

(71) Applicant: QUALCOMM Incorporated, San Diego, CA (US)

(72) Inventors: Sanjeevi S., Bangalore (IN); Nawneet KUMAR, Bangalore (IN); Vignesh BASKARAN, Bangalore (IN)

(21) Appl. No.: 18/991,195

(22) Filed: Dec. 20, 2024

(51) Int. Cl. G06T 1/20; G06T 1/60

(52) U.S. Cl. CPC G06T 1/20; G06T 1/60

(57) ABSTRACT

This disclosure provides systems, devices, apparatus, and methods, including computer programs encoded on storage media, for enhancing concurrent binning. A graphics processor may receive an indication of a first and second workload. The graphics processor may determine a minimum dependent draw call associated with a bin visibility pass of the second workload and a bin render pass of the first workload. The graphics processor may identify a first portion of the second workload and a second portion of the second workload corresponding to the determined minimum dependent draw call. The graphics processor may concurrently process the first workload via a bin render pass pipeline and the first portion of the second workload via a bin visibility pass pipeline. The graphics processor may process, after the processing of the second workload via the bin render pass pipeline, the second portion of the second workload via the bin visibility pass pipeline.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques may not address dependency overhead between bin visibility passes and bin rendering passes. There is a need for improved concurrent binning techniques.

### BRIEF SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a memory; and at least one processor coupled to the memory and, based at least in part on information stored in the memory, the at least one processor may be configured to receive an indication of a first workload and a second workload. The at least one processor may be configured to determine a minimum dependent draw call associated with a bin visibility pass of the second workload and a bin render pass of the first workload. The at least one processor may be configured to identify a first portion of the second workload and a second portion of the second workload corresponding to the determined minimum dependent draw call. The at least one processor may be configured to concurrently process the first workload via a bin render pass pipeline and the first portion of the second workload via a bin visibility pass pipeline. The at least one processor may be configured to process, after the processing of the second workload via the bin render pass pipeline, the second portion of the second workload via the bin visibility pass pipeline.

In some aspects, the techniques described herein relate to a method of graphics processing, including: receiving an indication of a first workload and a second workload; determining a minimum dependent draw call associated with a bin visibility pass of the second workload and a bin render pass of the first workload; identifying a first portion of the second workload and a second portion of the second workload corresponding to the determined minimum dependent draw call; concurrently processing the first workload via a bin render pass pipeline and the first portion of the second workload via a bin visibility pass pipeline; and processing, after the processing of the second workload via the bin render pass pipeline, the second portion of the second workload via the bin visibility pass pipeline.

In some aspects, the techniques described herein relate to a method, further including: determining a resource table associated with the bin render pass of the first workload before determining the minimum dependent draw call associated with the bin visibility pass of the second workload and the bin render pass of the first workload.

In some aspects, the techniques described herein relate to a method, where determining the minimum dependent draw call associated with the bin visibility pass of the second workload and the bin render pass of the first workload includes: determining the minimum dependent draw call based on the determined resource table.

In some aspects, the techniques described herein relate to a method, where determining the resource table associated with the bin render pass of the first workload includes: determining a set of resources associated with the bin render pass of the first workload; adding, to the resource table, a memory address for each resource of the set of resources associated with the bin render pass of the first workload; adding, to the resource table, an indicator of whether each added memory address is associated with a read command or a write command; and adding, to the resource table, an indicator of a dependent draw call associated with each resource of the set of resources.

In some aspects, the techniques described herein relate to a method, where determining the minimum dependent draw call associated with the bin visibility pass of the second workload and the bin render pass of the first workload includes: determining a second set of resources associated with the bin visibility pass of the second workload; identifying a subset of the second set of resources that are associated with the resource table and a bin render pass write command; and determining the minimum dependent draw call based on each corresponding dependent draw call associated with the identified subset of the second set of resources.

In some aspects, the techniques described herein relate to a method, where determining the resource table associated with the bin render pass of the first workload includes: determining, via a driver of a graphics processor, the resource table associated with the bin render pass of the first workload.

In some aspects, the techniques described herein relate to a method, where determining the minimum dependent draw call associated with the bin visibility pass of the second workload and the bin render pass of the first workload includes: determining, via a command processor (CP), the minimum dependent draw call associated with the bin visibility pass of the second workload and the bin render pass of the first workload.

In some aspects, the techniques described herein relate to a method, further including: processing the first workload via the bin visibility pass pipeline before concurrently processing the first workload via the bin render pass pipeline and the first portion of the second workload via the bin visibility pass pipeline.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system, in accordance with one or more techniques of this disclosure.

FIG. 2 illustrates an example GPU, in accordance with one or more techniques of this disclosure.

FIG. 3 illustrates an example image or surface, in accordance with one or more techniques of this disclosure.

FIG. 4 illustrates an example of scheduling for a binning pipeline, in accordance with one or more techniques of this disclosure.

FIG. 5 illustrates an example of concurrent scheduling for a bin visibility pipeline and a bin rendering pipeline, in accordance with one or more techniques of this disclosure.

FIG. 6 illustrates another example of concurrent scheduling for a bin visibility pipeline and a bin rendering pipeline, in accordance with one or more techniques of this disclosure.

FIG. 7 is a call flow diagram illustrating example communications between a CPU and a GPU in accordance with one or more techniques of this disclosure.

FIG. 8 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

The following description is directed to examples for the purposes of describing innovative aspects of this disclosure. However, a person having ordinary skill in the art may recognize that the teachings herein may be applied in a multitude of ways. Some or all of the described examples may be implemented in any device or system that is capable of processing graphics commands. Various aspects relate generally to reprojecting and/or composing frames for a graphics processing unit (GPU). Some aspects more specifically relate to applying reprojection fallback strategies during an excess system load (e.g., when a reprojection process for a frame will not complete in time to display the frame). For example, a graphics system may have limited dynamic random access memory (DRAM) bandwidth due to concurrent work (e.g., rendering, GPU workload, high-intensity periods of camera data acquisition), software control latencies (e.g., poorly optimized code, latencies when communicating with third-party applications), bottlenecking hardware execution, and/or power/thermal throttling. Such loads may affect the calculated projected time for a reprojection process to complete within a threshold period of time. Use of remotely-rendered framebuffers (e.g., frames processed by a reprojection topology on a separate system, or a third-party system), may also affect the time to render a frame. For example, use of a second reprojection process may conserve resources if a first reprojection process uses remote-rendered framebuffers having a high calculated latency value, or if a first reprojection process uses a large amount of bandwidth (e.g., WiFi, 5G bandwidth) and a system is configured to conserve use of that bandwidth with respect to transmission/reception of remote-rendered frames.

A graphics processor may be configured to concurrently process workloads via different pipelines. Concurrent processing means that execution of a portion of a first workload via a first pipeline occurs at the same time that execution of a portion of a second workload via a second pipeline occurs. In some aspects, concurrent processing may include a shader of a pipeline executing at the same time as a shader of a second pipeline. In some aspects, execution that occurs at the same time, or simultaneous execution, may also be defined to occur within the same time period, where the time period is within a threshold amount of time, for example within 5 milliseconds or within one millisecond. In concurrent binning, a visibility pass of a first workload may be executed via a bin visibility pipeline and a render pass of a previous workload may be executed in a bin render pipeline simultaneously during a same time period. The visibility pass of the previous workload may have been completed via the bin visibility pipeline during a previous time period before the aforementioned same time period. A dependency hazard in a visibility pass of a workload may stall the execution of visibility pass in the bin visibility pipeline until the dependent workload completes its execution in the bin render pipeline. In other words, a dependency hazard in a visibility pass of a workload may stall the entire workload. A workload may include a set of resources scheduled for graphics processing, for example rendering by a graphics processor. A workload may be processed in a bin visibility pass or a bin rendering pass of the graphics processor. A bin visibility pass of a workload may include processing of the workload using a bin visibility pipeline A bin rendering pass of a workload may include processing of the workload using a bin rendering pipeline A workload may include any number of draws or draw calls. In some aspects, segmenting the workloads to avoid stalling processing a visibility pass may unduly increase the driver overhead. In some aspects, a graphics processing system may include a mechanism to allow execution of the visibility pass on all draws prior to the draw which introduces the dependency hazard. For example, every resource added in a resource list may be added with the draw number associated with its first use in the workload. The command processor may read this data and allow execution of the visibility pass of all draws before the draw which introduces the dependency.

In some examples, a graphics processor (or graphics processor system) may receive an indication of a first workload and a second workload for processing by the graphics processor. The graphics processor may determine a minimum dependent draw call associated with a bin visibility pass of the second workload and a bin render pass of the first workload. A minimum dependent draw call may be a lowest, or earliest, draw call dependency. For example, a resource of the second workload to be processed by a bin visibility pipeline may be dependent upon a resource of the first workload being rendered by a bin rendering pipeline. The rendering of the dependent resource may be referred to as a dependent draw call. The graphics processor may identify a first portion of the second workload and a second portion of the second workload corresponding to the determined minimum dependent draw call. For example, the first portion may be resources of the second workload positioned before the determined minimum dependent draw call and the second portion may be resources of the second workload positioned at, or after the determined minimum dependent draw call. The graphics processor may concurrently process the first workload via a bin render pass pipeline and the first portion of the second workload via a bin visibility pass pipeline. Execution of a portion of the first workload via the bin render pass pipeline may occur at the same time that execution of a portion of the second workload occurs. In some aspects, concurrent processing by the bin visibility pass pipeline and the bin render pass pipeline may include a shader of the bin visibility pass pipeline executing at the same time as a shader of the bin render pass pipeline. A bin visibility pass pipeline may include a set of hardware used to determine whether a primitive of a workload is visible, where at least one subset of the set of hardware is dedicated towards determining whether a primitive of the workload is visible and not towards rendering a primitive of the workload. A bin render pass pipeline may include a set of hardware used to render a primitive of a workload, where at least one subset of the set of hardware is dedicated towards rendering a primitive of the workload and not towards determining whether a primitive is visible. In other words, a portion of the bin visibility pass pipeline may not overlap with processing a workload for rendering, and a portion of the bin render pass pipeline may not overlap with processing a workload for determining if a primitive is visible. A graphics processor may perform hazard tracking based on draw calls of the resources using a resource table. The resource table may be any logical data storage system that may be used to track resources used by a draw call of a workload. The graphics processor may add each resource to the resource table with the draw number in which the resource is first used in the previous workload. In other aspects, a driver may be configured to add each resource in the resource list with the draw number in which it is first used in the workload. In some aspects, a driver of a graphics processor may be configured to add a memory address, an indicator of whether the memory address is associated with a read command or a write command, and an indicator of which dependent draw call is associated with the resource to the resource table. In other aspects, the resource table may not have a draw call number. In some aspects, a driver of the graphics processor may blindly add resources to the resource table and may keep a running tally of the minimum draw call, while the CP decodes the resource list and determines resource dependencies.

The graphics processor may process, after the processing of the second workload via the bin render pass pipeline, the second portion of the second workload via the bin visibility pass pipeline. In other words, the graphics processor may save time by concurrently processing both non-dependent resources of a current workload in a bin visibility pass and resources of a subsequent workload in a bin rendering pass. After the bin rendering pass is completed, the graphics processor may process dependent resources of the current workload, as the dependent resources have already been rendered by the bin rendering pass of the subsequent workload.

Particular aspects of the subject matter described in this disclosure can be implemented to realize one or more of the following potential advantages. In some examples, by enabling the execution of visibility pass draws before a draw call that introduces a resource dependency, the described techniques can be used to increase the amount of time saved via concurrent binning techniques.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

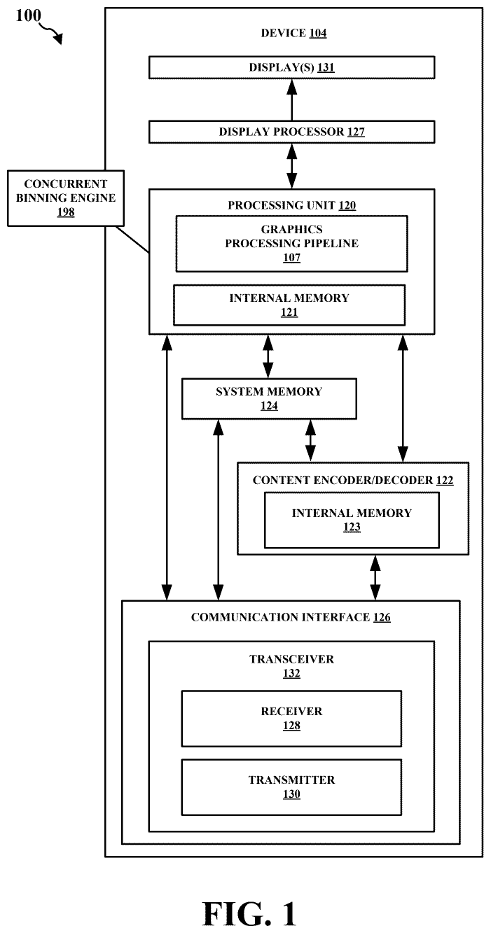

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors. A set of processors configured to perform a set of tasks may be configured to perform the set of tasks individually, or in any combination.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 include a concurrent binning engine 198 configured to receive an indication of a first workload and a second workload. The concurrent binning engine 198 may be configured to determine a minimum dependent draw call associated with a bin visibility pass of the second workload and a bin render pass of the first workload. The concurrent binning engine 198 may be configured to identify a first portion of the second workload and a second portion of the second workload corresponding to the determined minimum dependent draw call. The concurrent binning engine 198 may be configured to concurrently process the first workload via a bin render pass pipeline and the first portion of the second workload via a bin visibility pass pipeline. The concurrent binning engine 198 may be configured to process, after the processing of the second workload via the bin render pass pipeline, the second portion of the second workload via the bin visibility pass pipeline. Although the following description may be focused on graphics processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

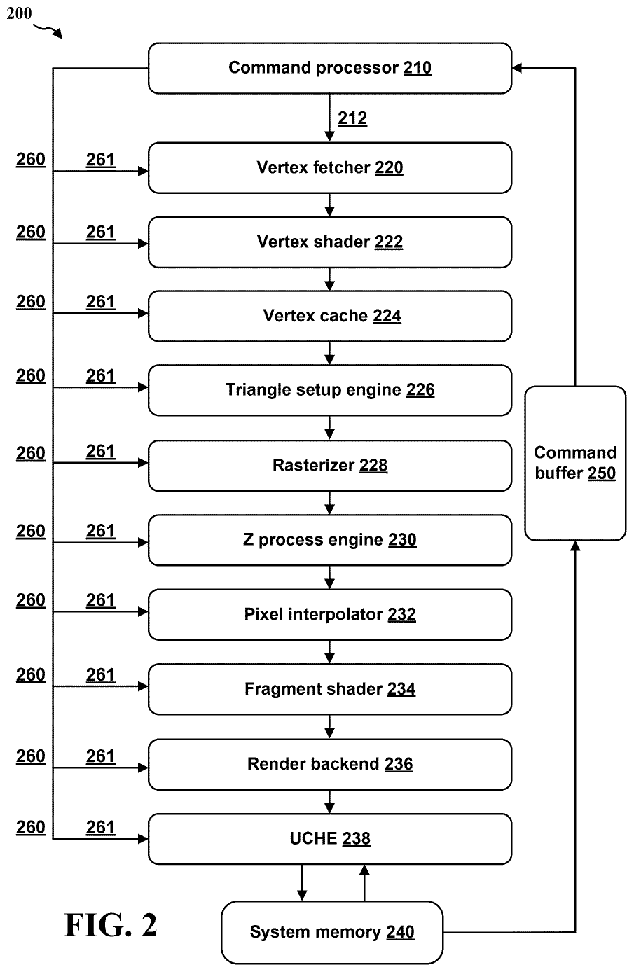

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

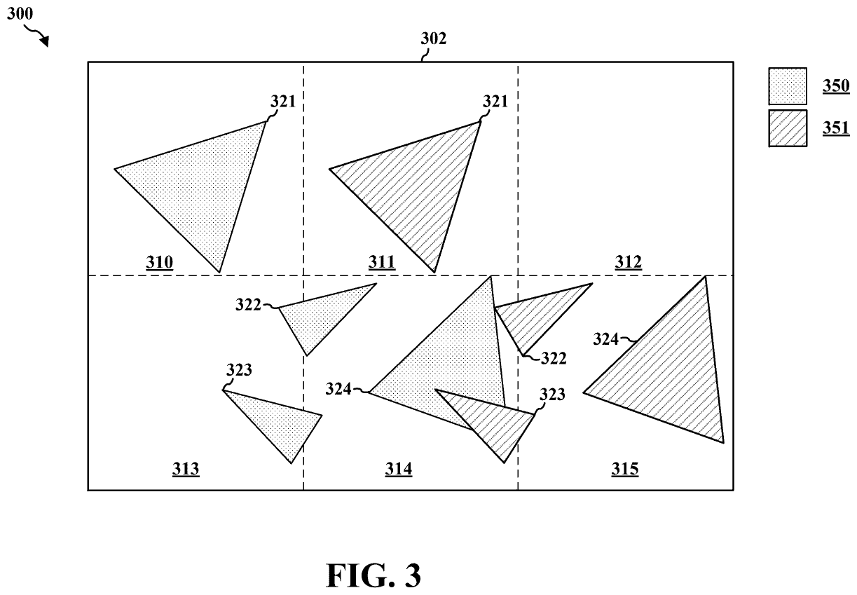

FIG. 3 illustrates image or surface 300, including multiple primitives divided into multiple bins in accordance with one or more techniques of this disclosure. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 can utilize multiple viewpoints or multi-view rendering.

As indicated herein, GPUs or graphics processors can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

As indicated herein, in some aspects, such as in bin or tiled rendering architecture, frame buffers can have data stored or written to them repeatedly, e.g., when rendering from different types of memory. This can be referred to as resolving and unresolving the frame buffer or system memory. For example, when storing or writing to one frame buffer and then switching to another frame buffer, the data or information on the frame buffer can be resolved from the GMEM at the GPU to the system memory, i.e., memory in the double data rate (DDR) RAM or dynamic RAM (DRAM).

In some aspects, the system memory can also be system-on-chip (SoC) memory or another chip-based memory to store data or information, e.g., on a device or smart phone. The system memory can also be physical data storage that is shared by the CPU and/or the GPU. In some aspects, the system memory can be a DRAM chip, e.g., on a device or smart phone. Accordingly, SoC memory can be a chip-based manner in which to store data.

In some aspects, the GMEM can be on-chip memory at the GPU, which can be implemented by static RAM (SRAM). Additionally, GMEM can be stored on a device, e.g., a smart phone. As indicated herein, data or information can be transferred between the system memory or DRAM and the GMEM, e.g., at a device. In some aspects, the system memory or DRAM can be at the CPU or GPU. Additionally, data can be stored at the DDR or DRAM. In some aspects, such as in bin or tiled rendering, a small portion of the memory can be stored at the GPU, e.g., at the GMEM. In some instances, storing data at the GMEM may utilize a larger processing workload and/or consume more power compared to storing data at the frame buffer or system memory.

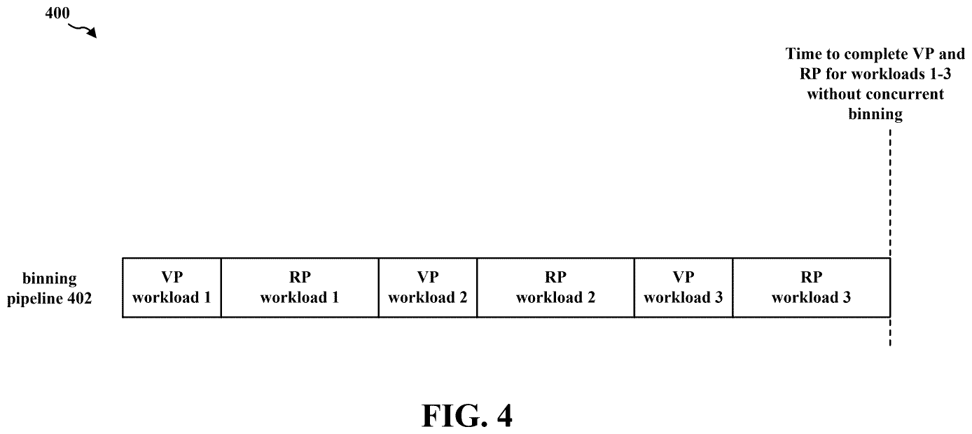

FIG. 4 is a diagram 400 illustrating a binning pipeline 402, which may be configured to process a workload in a bin visibility pass and a bin rendering pass. For example, a graphics processor may schedule a visibility pass (VP) of workload 1 via the binning pipeline 402, and after the VP of workload 1 has completed, the graphics processor may start processing a rendering pass (RP) of workload 1 via the binning pipeline 402. After the RP of workload 1 has completed, the graphics processor may start processing a VP of workload 2 via the binning pipeline 402. After the VP of workload 2 has completed, the graphics processor may start processing an RP of workload 2 via the binning pipeline 402. After the RP of workload 2 has completed, the graphics processor may start processing a VP of workload 3 via the binning pipeline 402. After the VP of workload 3 has completed, the graphics processor may start processing an RP of workload 3 via the binning pipeline 402. In other words, the binning pipeline 402 may be configured to serially handle a visibility pass and then a rendering pass of each workload input buffered for the binning pipeline 402. However, in order to reduce binning overhead, a graphics processor may be configured to start processing a binning pass of a subsequent workload during the rendering pass of the current workload.

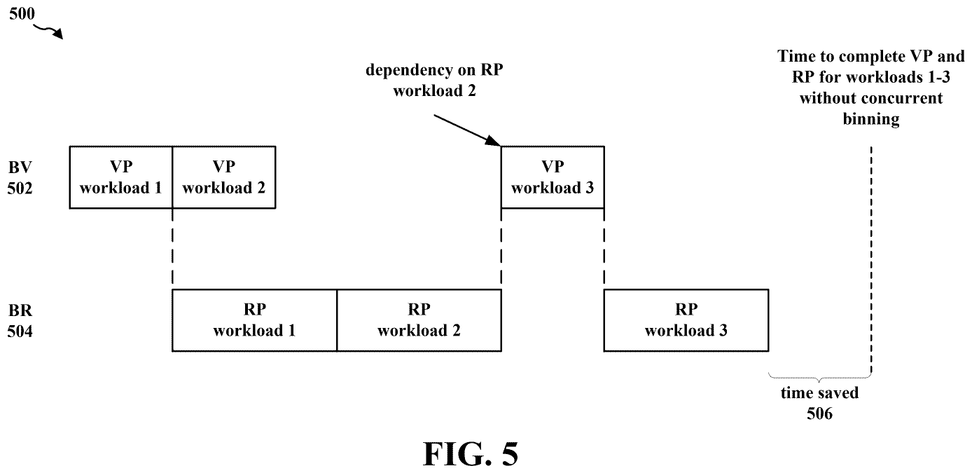

FIG. 5 is a diagram 500 illustrating a bin visibility (BV) pipeline, or BV 502 and a bin rendering (BR) pipeline, or BR 504 which may operate in parallel. In other words, the BV 502 may process a first workload at the same time as the BR 504 processes a second workload. In one example, a graphics processor may schedule a VP of workload 1 via the BV 502. After the VP of workload 1 has completed, the graphics processor may concurrently process an RP of workload 1 via the BR 504 while processing a VP of workload 2 via the BV 502. However, at least one of the VP resources of workload 3 may be dependent upon a rendered resource of workload 2. As a result, the graphics processor may stall the VP of workload 3 until the RP of workload 2 completes. After the RP of workload 2 has completed, the graphics processor may start processing a VP of workload 3 via the BV 502, and then may start processing an RP of workload 3 via the BR 504.

By concurrently executing the VP of workload 2 via the BV 502 and the RP of workload 1 via the BR 504, the graphics processor may save an amount of time 506 from the time that it would normally take the graphics processor to complete processing workloads 1, 2, and 3 serially using a single binning pipeline. However, where these is a resource dependency between workloads, a binning pass of a later workload cannot be executed parallelly with the rendering pass of the former workload. Since a workload may contain any number of draw calls, the resource dependency may be due to the draws which are at the end of the workload. This means that it's possible that concurrent binning may be performed at the beginning of the workload, and the tail end of the workload that contains the resource dependency may be stalled, instead of the entire workload.

A graphics processor may save additional time by tracking each draw call, and by concurrently processing any non-dependent resources of a workload during a visibility pass while stalling dependent resources of the workload. In some aspects, a driver may be configured to track each draw call in a separate workload, allowing for non-dependent resources to be processed concurrently in a bin visibility pass, and for dependent resources to be processed serially after a bin rendering pass of the previous workload. However, configuring a driver to track each and every resource may massively increase the overhead of the driver.

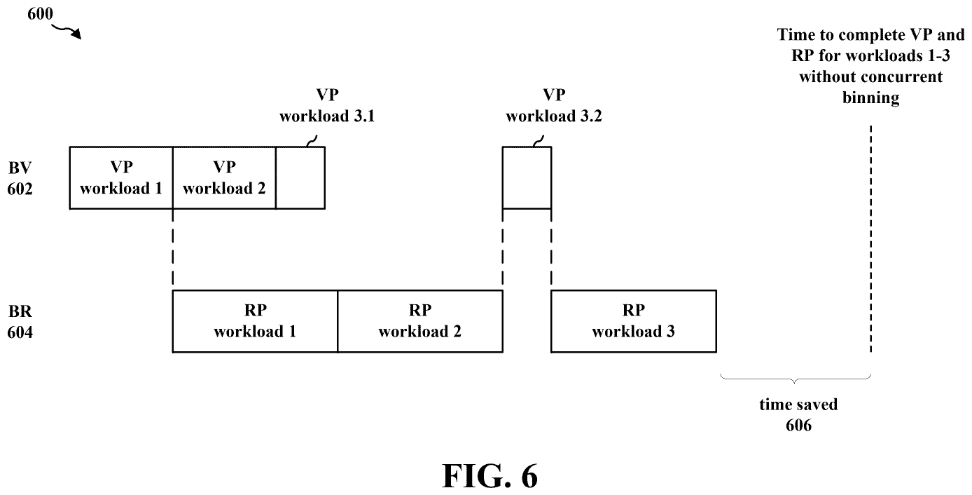

FIG. 6 is a diagram 600 illustrating a BV pipeline, or BV 602 and a BR pipeline, or BR 604 which may operate in parallel similar to the BV 502 and the BR 504 of FIG. 5. In other words, the BV 602 may process a first workload at the same time as the BR 604 processes a second workload. In one example, a graphics processor may schedule a VP of workload 1 via the BV 602. After the VP of workload 1 has completed, the graphics processor may concurrently process an RP of workload 1 via the BR 604 while processing a VP of workload 2 via the BV 602. However, at least one of the VP resources of workload 3 may be dependent upon a rendered resource of workload 2. The resource dependency may be due to the draws which are at the end of workload 3.

A graphics processor may perform hazard tracking based on draw calls of the resources. In some aspects, each resource added to a resource table may be added with the draw number in which the resource is first used in the previous workload. A resource table may be a common table that tracks a resource address for each resource, and an indicator of whether the resource is associated with a read command, whether the resource is associated with a write command, or whether the resource is associated with both a read command and a write command. In some aspects, a driver of a graphics processor may be configured to add a memory address, an indicator of whether the memory address is associated with a read command or a write command, and an indicator of which dependent draw call is associated with the resource to the resource table. A driver may be configured to add the draw number to the resource table. The command processor (CP) in a graphics processor may be configured to process this data and allow the execution of a BV pass of all of the prior draws before the draw that introduces the resource dependency, providing room to enhance the concurrency. In some aspects, a CP may be configured to read from the resource table during the execution of bin visibility pass in a binning pipeline in order to determine a minimum draw call for a workload.

In some aspects, a concurrent binning engine may track resource hazards, also referred to as dependency hazards, in concurrent binning. The resources may include bin render pass resources, also referred to as write resources. Bin render pass resources may include resources that are written, or produced, during a bin render pass. The concurrent binning engine may add indicators of the resource to the resource table, also referred to as a CP resource list table. The resources may include bin visibility pass resources, also referred to as read resources. Bin visibility pass resources may include resources that are read, or consumed, during a bin visibility pass. The concurrent binning engine may compare these resources against existing resources present in the resource table to determine the minimum draw call that is associated with a resource hazard, or dependency hazard. The minimum draw call may be the earliest draw call in a workload that has a resource hazard, or dependency hazard, with a render pass of a previous workload.

As shown in FIG. 6, the graphics processor may split the workload 3 into a first portion 3.1 and a second portion 3.2, where workload 3.1 represents the resources in workload 3 positioned before the first draw call of workload 3 that includes a resource dependency, and workload 3.2 represents the resources in workload 3 positioned at or after the first draw call of workload 3 that includes a resource dependency. As a result, the graphics processor may concurrently process the VP of workload 3.1 via the BV 602 during an RP of the BR and may stall the VP of workload 3.2 via the BV 602 until after the RP of the workload 2 via the BR 604. The first draw call of workload 3.2 may be the tracked minimum draw call that is associated with a resource hazard. After the RP of the workload 2 via the BR 604, the graphics processor may start processing a VP of workload 3.2 via the BV 602, and then may start processing an RP of workload 3 via the BR 604. This ensures that the dependent resources used by the minimum draw call in workload 3.2 is first rendered via the BR 604 in workload 2 before being read by the BV 602 in workload 3.2.

By concurrently executing the VP of workload 3.1 via the BV 602 and the RP of workloads via the BR 604, the graphics processor may save an amount of time 606 from the time that it would normally take the graphics processor to complete processing workloads 1, 2, and 3 serially using a single binning pipeline. The amount of time 606 saved by splitting workloads based on resource dependencies may be greater than the amount of time 506 saved by stalling entire workloads based on resource dependencies.

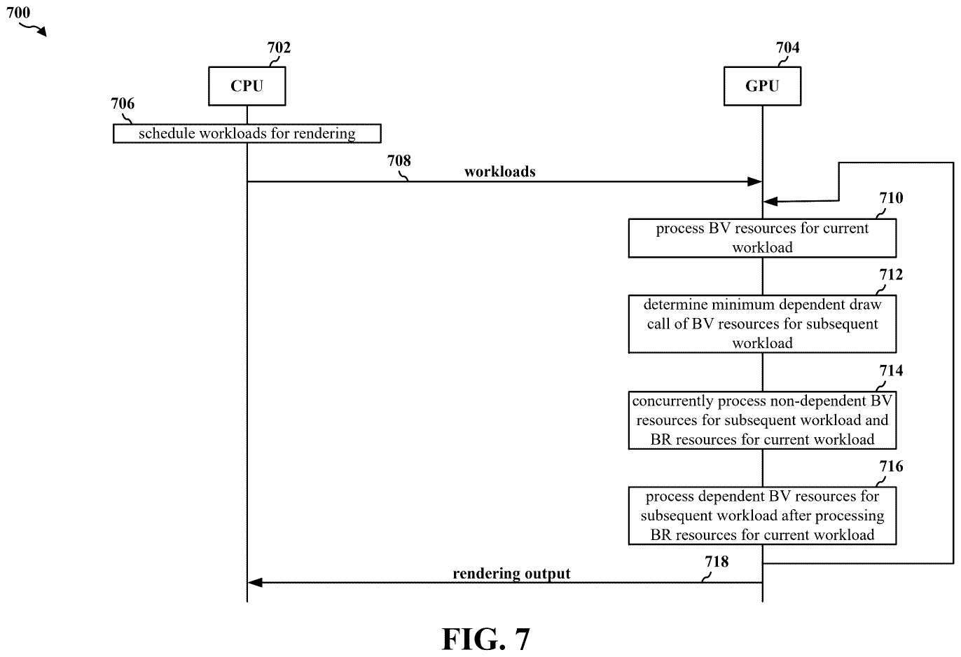

FIG. 7 is a call flow diagram 700 illustrating example communications between a CPU 702 and a GPU 704. At 706, the CPU 702 may schedule a plurality of workloads for rendering by the GPU 704. The CPU 702 may output an indication 708 of the plurality of workloads to the GPU 704. The GPU 704 may obtain the indication 708 of the plurality of workloads from the CPU 702.

At 710, the GPU 704 may process BV resources for a first workload. In other words, the GPU 704 may generate a resource list and process the first workload via a BV pipeline of the GPU 704. At 712, the GPU 704 may determine a minimum dependent draw call of BV resources for a second workload. In other words, the GPU 704 may compare the resources of a BV of the second workload against a resource table associated with a BR of the first workload. For every resource of the BV of the second workload that is in the resource table and is associated with a write command (i.e., is dependent upon a rendering draw call), the GPU 704 may record the dependent draw call so long as the number of the draw call is lower than the last recorded dependent draw call. In other words, the GPU 704 may record the lowest dependent draw call. At 714, the GPU 704 may concurrently process the non-dependent BV resources for the second workload while processing the BR resources for the first workload. At 716, after the GPU 704 has finished processing the BR resources for the first workload, the GPU 704 may process the dependent BV resources for the second workload. The GPU 704 may repeat this process for every current-subsequent workload pair until the GPU 704 has processed all of the workloads indicated by the indication 708 of the plurality of workloads. The GPU 704 may output an indication 718 of completion of rendering to the CPU 702. The CPU 702 may obtain the indication 718 of completion of the rendering from the GPU 704.

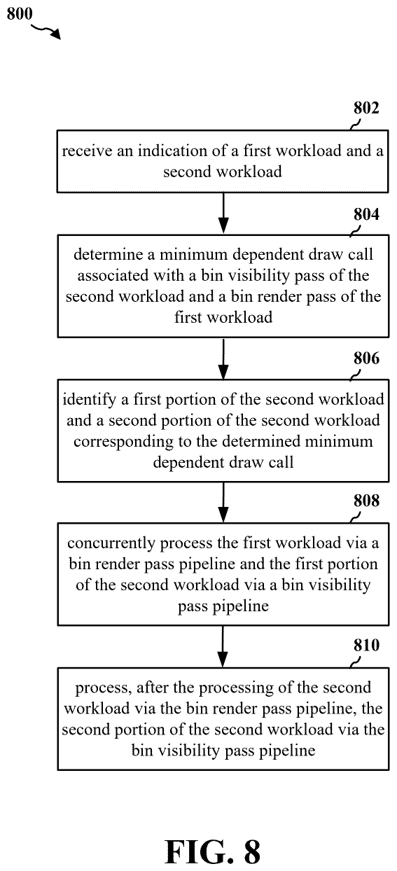

FIG. 8 is a flowchart 800 of an example method of graphics processing in accordance with one or more techniques of this disclosure. The method may be performed by an apparatus, such as an apparatus for graphics processing, a GPU, a CPU, a wireless communication device, and the like, as used in connection with the aspects of FIGS. 1-7.

At 802, the apparatus may receive an indication of a first workload and a second workload. For example, referring to FIG. 7, the GPU 704 may perform 802 by receive an indication of a first workload and a second workload. Moreover, 802 may be performed by the concurrent binning engine 198 of FIG. 1.

At 804, the apparatus may determine a minimum dependent draw call associated with a bin visibility pass of the second workload and a bin render pass of the first workload. For example, referring to FIG. 7, the GPU 704 may perform 804 by determine a minimum dependent draw call associated with a bin visibility pass of the second workload and a bin render pass of the first workload. Moreover, 804 may be performed by the concurrent binning engine 198 of FIG. 1.

At 806, the apparatus may identify a first portion of the second workload and a second portion of the second workload corresponding to the determined minimum dependent draw call. For example, referring to FIG. 7, the GPU 704 may perform 806 by identify a first portion of the second workload and a second portion of the second workload corresponding to the determined minimum dependent draw call. Moreover, 806 may be performed by the concurrent binning engine 198 of FIG. 1.

At 808, the apparatus may concurrently process the first workload via a bin render pass pipeline and the first portion of the second workload via a bin visibility pass pipeline. For example, referring to FIG. 7, the GPU 704 may perform 808 by concurrently process the first workload via a bin render pass pipeline and the first portion of the second workload via a bin visibility pass pipeline. Moreover, 808 may be performed by the concurrent binning engine 198 of FIG. 1.

At 810, the apparatus may process, after the processing of the second workload via the bin render pass pipeline, the second portion of the second workload via the bin visibility pass pipeline. For example, referring to FIG. 7, the GPU 704 may perform 810 by process, after the processing of the second workload via the bin render pass pipeline, the second portion of the second workload via the bin visibility pass pipeline. Moreover, 810 may be performed by the concurrent binning engine 198 of FIG. 1.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for receiving an indication of a first workload and a second workload. The apparatus may further include means for determining a minimum dependent draw call associated with a bin visibility pass of the second workload and a bin render pass of the first workload. The apparatus may further include means for identifying a first portion of the second workload and a second portion of the second workload corresponding to the determined minimum dependent draw call. The apparatus may further include means for concurrently processing the first workload via a bin render pass pipeline and the first portion of the second workload via a bin visibility pass pipeline. The apparatus may further include means for processing, after the processing of the second workload via the bin render pass pipeline, the second portion of the second workload via the bin visibility pass pipeline

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of graphics processing, comprising: receiving an indication of a first workload and a second workload; determining a minimum dependent draw call associated with a bin visibility pass of the second workload and a bin render pass of the first workload; identifying a first portion of the second workload and a second portion of the second workload corresponding to the determined minimum dependent draw call; concurrently processing the first workload via a bin render pass pipeline and the first portion of the second workload via a bin visibility pass pipeline; and processing, after the processing of the second workload via the bin render pass pipeline, the second portion of the second workload via the bin visibility pass pipeline.

Aspect 2 is the method of aspect 1, further comprising: determining a resource table associated with the bin render pass of the first workload before determining the minimum dependent draw call associated with the bin visibility pass of the second workload and the bin render pass of the first workload.

Aspect 3 is the method of aspect 2, wherein determining the minimum dependent draw call associated with the bin visibility pass of the second workload and the bin render pass of the first workload comprises: determining the minimum dependent draw call based on the determined resource table.

Aspect 4 is the method of either of aspects 2 or 3, wherein determining the resource table associated with the bin render pass of the first workload comprises: determining a set of resources associated with the bin render pass of the first workload; adding, to the resource table, a memory address for each resource of the set of resources associated with the bin render pass of the first workload; adding, to the resource table, an indicator of whether each added memory address is associated with a read command or a write command; and adding, to the resource table, an indicator of a dependent draw call associated with each resource of the set of resources.

Aspect 5 is the method of aspect 4, wherein determining the minimum dependent draw call associated with the bin visibility pass of the second workload and the bin render pass of the first workload comprises: determining a second set of resources associated with the bin visibility pass of the second workload; identifying a subset of the second set of resources that are associated with the resource table and a bin render pass write command; and determining the minimum dependent draw call based on each corresponding dependent draw call associated with the identified subset of the second set of resources.

Aspect 6 is the method of any of aspects 2 to 5, wherein determining the resource table associated with the bin render pass of the first workload comprises: determining, via a driver of a graphics processor, the resource table associated with the bin render pass of the first workload.

Aspect 7 is the method of any of aspects 1 to 6, wherein determining the minimum dependent draw call associated with the bin visibility pass of the second workload and the bin render pass of the first workload comprises: determining, via a command processor (CP), the minimum dependent draw call associated with the bin visibility pass of the second workload and the bin render pass of the first workload.

Aspect 8 is the method of any of aspects 1 to 7, further comprising: processing the first workload via the bin visibility pass pipeline before concurrently processing the first workload via the bin render pass pipeline and the first portion of the second workload via the bin visibility pass pipeline.

Aspect 9 is an apparatus for graphics processing including at least one processor coupled to a memory and configured to implement a method as in any of aspects 1-8.

Aspect 10 may be combined with aspect 9 and includes that the apparatus includes a wireless communication device.

Aspect 11 is an apparatus for graphics processing including means for implementing a method as in any of aspects 1-8.

Aspect 12 is a computer-readable medium (e.g., a non-transitory computer-readable medium) storing computer executable code, the code when executed by at least one processor causes the at least one processor to implement a method as in any of aspects 1-8.

Various aspects have been described herein. These and other aspects are within the scope of the following claims.

What is claimed is:

1. An apparatus for graphics processing, comprising:
a memory; and
a processor coupled to the memory and, based at least in part on information stored in the memory, the processor is configured to:
receive an indication of a first workload and a second workload;
determine a minimum dependent draw call associated with a bin visibility pass of the second workload and a bin render pass of the first workload;
identify a first portion of the second workload and a second portion of the second workload corresponding to the determined minimum dependent draw call;
concurrently process the first workload via a bin render pass pipeline and the first portion of the second workload via a bin visibility pass pipeline; and
process, after the processing of the second workload via the bin render pass pipeline, the second portion of the second workload via the bin visibility pass pipeline.

2. The apparatus of claim 1, wherein the processor is further configured to:
determine a resource table associated with the bin render pass of the first workload before the determination of the minimum dependent draw call associated with the bin visibility pass of the second workload and the bin render pass of the first workload.

3. The apparatus of claim 2, wherein, to determine the minimum dependent draw call associated with the bin visibility pass of the second workload and the bin render pass of the first workload, the processor is configured to:
determine the minimum dependent draw call based on the determined resource table.

4. The apparatus of claim 2, wherein, to determine the resource table associated with the bin render pass of the first workload, the processor is configured to:
determine a set of resources associated with the bin render pass of the first workload;
add, to the resource table, a memory address for each resource of the set of resources associated with the bin render pass of the first workload;
add, to the resource table, an indicator of whether each added memory address is associated with a read command or a write command; and
add, to the resource table, an indicator of a dependent draw call associated with each resource of the set of resources.

5. The apparatus of claim 4, wherein, to determine the minimum dependent draw call associated with the bin visibility pass of the second workload and the bin render pass of the first workload, the processor is configured to:
determine a second set of resources associated with the bin visibility pass of the second workload;
identify a subset of the second set of resources that are associated with the resource table and a bin render pass write command; and
determine the minimum dependent draw call based on each corresponding dependent draw call associated with the identified subset of the second set of resources.

6. The apparatus of claim 1, wherein, to determine the minimum dependent draw call associated with the bin visibility pass of the second workload and the bin render pass of the first workload, the processor is configured to:
determine, via a command processor (CP), the minimum dependent draw call associated with the bin visibility pass of the second workload and the bin render pass of the first workload.

7. The apparatus of claim 1, wherein the processor is further configured to:
process the first workload via the bin visibility pass pipeline before concurrently processing the first workload via the bin render pass pipeline and the first portion of the second workload via the bin visibility pass pipeline.

8. The apparatus of claim 1, wherein the apparatus comprises a wireless communication device.

9. A method of graphics processing, comprising:
receiving an indication of a first workload and a second workload;
determining a minimum dependent draw call associated with a bin visibility pass of the second workload and a bin render pass of the first workload;
identifying a first portion of the second workload and a second portion of the second workload corresponding to the determined minimum dependent draw call;
concurrently processing the first workload via a bin render pass pipeline and the first portion of the second workload via a bin visibility pass pipeline; and
processing, after the processing of the second workload via the bin render pass pipeline, the second portion of the second workload via the bin visibility pass pipeline.

10. The method of claim 9, further comprising:
determining a resource table associated with the bin render pass of the first workload before the determination of the minimum dependent draw call associated with the bin visibility pass of the second workload and the bin render pass of the first workload.

11. The method of claim 10, wherein determining the minimum dependent draw call associated with the bin visibility pass of the second workload and the bin render pass of the first workload comprises:
determining the minimum dependent draw call based on the determined resource table.

12. The method of claim 10, wherein determining the resource table associated with the bin render pass of the first workload comprises:
determining a set of resources associated with the bin render pass of the first workload;
adding, to the resource table, a memory address for each resource of the set of resources associated with the bin render pass of the first workload;
adding, to the resource table, an indicator of whether each added memory address is associated with a read command or a write command; and
adding, to the resource table, an indicator of a dependent draw call associated with each resource of the set of resources.

13. The method of claim 12, wherein determining the minimum dependent draw call associated with the bin visibility pass of the second workload and the bin render pass of the first workload comprises:
determining a second set of resources associated with the bin visibility pass of the second workload;
identifying a subset of the second set of resources that are associated with the resource table and a bin render pass write command; and
determining the minimum dependent draw call based on each corresponding dependent draw call associated with the identified subset of the second set of resources.

14. The method of claim 9, wherein determining the minimum dependent draw call associated with the bin visibility pass of the second workload and the bin render pass of the first workload comprises:
determining, via a command processor (CP), the minimum dependent draw call associated with the bin visibility pass of the second workload and the bin render pass of the first workload.

15. The method of claim 9, further comprising:
processing the first workload via the bin visibility pass pipeline before concurrently processing the first workload via the bin render pass pipeline and the first portion of the second workload via the bin visibility pass pipeline.

16. A computer-readable medium storing computer executable code, the code when executed by a processor, causes the processor to:
receive an indication of a first workload and a second workload;
determine a minimum dependent draw call associated with a bin visibility pass of the second workload and a bin render pass of the first workload;
identify a first portion of the second workload and a second portion of the second workload corresponding to the determined minimum dependent draw call;
concurrently process the first workload via a bin render pass pipeline and the first portion of the second workload via a bin visibility pass pipeline; and
process, after the processing of the second workload via the bin render pass pipeline, the second portion of the second workload via the bin visibility pass pipeline.

17. The computer-readable medium of claim 16, wherein the code, when executed by the processor, further causes the processor to:
determine a resource table associated with the bin render pass of the first workload before the determination of the minimum dependent draw call associated with the bin visibility pass of the second workload and the bin render pass of the first workload, wherein, to determine the resource table associated with the bin render pass of the first workload, the code, when executed by the processor, causes the processor to:
determine a set of resources associated with the bin render pass of the first workload;
add, to the resource table, a memory address for each resource of the set of resources associated with the bin render pass of the first workload;
add, to the resource table, an indicator of whether each added memory address is associated with a read command or a write command; and
add, to the resource table, an indicator of a dependent draw call associated with each resource of the set of resources.

18. The computer-readable medium of claim 17, wherein to determine the minimum dependent draw call associated with the bin visibility pass of the second workload and the bin render pass of the first workload, the code, when executed by the processor, further causes the processor to:
determine a second set of resources associated with the bin visibility pass of the second workload;
identify a subset of the second set of resources that are associated with the resource table and a bin render pass write command; and
determine the minimum dependent draw call based on each corresponding dependent draw call associated with the identified subset of the second set of resources.

19. The computer-readable medium of claim 16, wherein to determine the minimum dependent draw call associated with the bin visibility pass of the second workload and the bin render pass of the first workload, the code, when executed by the processor, further causes the processor to:
determine, via a command processor (CP), the minimum dependent draw call associated with the bin visibility pass of the second workload and the bin render pass of the first workload.

20. The computer-readable medium of claim 16, wherein the code when executed by the processor, further causes the processor to:
process the first workload via the bin visibility pass pipeline before the concurrent processing the first workload via the bin render pass pipeline and the first portion of the second workload via the bin visibility pass pipeline.
